(19) United States
(12) Patent Application Publication
(10) Pub. No.: US 2026/0162405 A1
(43) Pub. Date: Jun. 11, 2026

(54) DE-IDENTIFICATION METHOD, BIOMETRIC INFORMATION PROCESSING METHOD BASED ON DE-IDENTIFICATION, AND APPARATUS THEREOF

(71) Applicant: FOUNDTION FOR RESEARCH AND BUSINESS, SEOUL NATIONAL UNIVERSITY OF SCIENCE AND TECHNOLOGY, Seoul (KR)

(72) Inventors: Jongyoul PARK, Seoul (KR); Jong Il PARK, Seoul (KR); Hyewon YOON, Seoul (KR)

(73) Assignee: FOUNDATION FOR RESEARCH AND BUSINESS, SEOUL NATIONAL UNIV OF SCI AND TECH, Seoul (KR)

(21) Appl. No.: 19/397,558

(22) Filed: Nov. 21, 2025

(30) Foreign Application Priority Data
Dec. 5, 2024 (KR) 10-2024-0179840

(51) Int. Cl. G06V 10/77; G06V 10/26; G06V 10/30; G06V 10/82; G06V 40/16

(52) U.S. Cl. CPC G06V 10/7715; G06V 10/26; G06V 10/30; G06V 10/82; G06V 40/171

(57) ABSTRACT

The present disclosure relates to a technology for protecting visual features within an image, and a de-identification method receives an image including a facial region, extracts feature information about the facial region from the input image, transforms the extracted feature information to provide a guide for a portion to be generated within the facial region, and performs de-identification based on the provided guide.

### CROSS REFERENCE TO RELATED APPLICATION

The present application claims priority to Korean Patent Application No. 10-2024-0179840, filed on Dec. 5, 2024, the entire contents of which is incorporated herein for all purposes by this reference.

### TECHNICAL FIELD

The present disclosure relates to a technology for protecting visual features within an image, and more specifically, to a method of de-identifying visual features within an image, a method of processing biometric information based on de-identification, and a device using the method.

### BACKGROUND

With the advancement of artificial intelligence technology, various forms of personal information are newly emerging. Among these, image information representing various characteristics of an individual in addition to facial information is being used as personal information.

The visual features are used to distinguish objects from one another. The visual features can be represented by various characteristics of visual objects in visual data. For object recognition within an image, various image features, such as scale invariant feature transform (SIFT), histogram of oriented gradient (HOG), speed-up robust feature (SURF), Haar, ferns, local binary pattern (LBP), and modified census transform (MCT), can be used. These visual features not only represent the unique characteristics of objects but also sometimes exhibit the unique characteristics of specific individuals, and thus are very important in terms of recognition and require protection.

With the advent of the artificial intelligence era, facial recognition technology is becoming widespread. For facial recognition, visual features for distinguishing a face can be extracted from an image including the face, which can raise privacy concerns. For example, visual features, that is, personal information, which can specify individuals from facial information from people moving on the street or photo information shared on social networks, can be leaked.

To prevent this personal information leakage, various de-identification techniques, which obscure visual features corresponding to personal information, have been proposed. The patent document presented below proposes a technical method for detecting and mosaicking facial regions within CCTV footage to protect an individual's privacy. However, applying a mosaic to the entire facial region can protect personal information, but constitutes a complete anonymization technique that makes it impossible to identify the individual, and is therefore unsuitable in situations in which visual recognition of the person in the footage is still required.

Accordingly, there is a need for the development of new technologies that can reveal a certain level of visual features within an image and also protect personal information.

[Patent Document] Korean Patent Registration No. 10-1612735, “facial analysis-based selective region mosaicing method.”

### SUMMARY

Various embodiments of the present disclosure are directed to solving a problem of personal information leakage that may arise when there are insufficient protection measures for visual features within images utilized in image recognition and the like, overcoming the weakness of conventional de-identification techniques that significantly modify or remove visual features within the original image, making it difficult to recognize the original person, and overcoming the limitation that, when a de-identification process is performed irreversibly, the visual features within the original image cannot be restored in situations in which identification data is later required.

In order to the above-described technical problems, in one aspect, there is provided a de-identification method comprising receiving an image including a facial region; extracting feature information about the facial region from the input image; transforming the extracted feature information to provide a guide for a portion to be generated within the facial region; and performing de-identification based on the provided guide.

The de-identification method may further comprise performing at least one preprocessing among shadow removal, noise removal, image modification, and color correction on the input image.

The extracting of the feature information may include at least one of extracting region-specific features from the input image in different region sizes; and performing masking on the input image in grid units of different sizes.

The extracting of the region-specific features may include segmenting an entire image region into exclusive regions of different sizes, extracting features of the corresponding image through transformation from a high-dimensional image to a low-dimensional image for each segmented exclusive region, and transforming the extracted features into a latent space; and supplying image information corresponding to a relatively smaller region as inputs to individual layers during the transformation process of image data corresponding to relatively larger regions, with the input adjusted to match the size of the larger regions.

The performing of the masking may include setting at least two or more segmentation criteria, segmenting the entire image region into grids of predetermined sizes according to the set segmentation criteria to extract structural features of the corresponding image for each grid, with grids segmented by different segmentation criteria overlapping in some regions; and aggregating the features extracted from each grid for each region to structure features corresponding to the entire image region. The performing of the masking may include extracting a skin feature from a relatively smaller grid among the segmented grids.

The providing of the guide may include removing or modifying the feature information corresponding to the portion to be newly generated within the facial region according to a preset transformation rule. The de-identification method may further comprise pre-storing or transmitting at least one of the feature information and the transformation rule or a combination thereof in or to a device configured to re-identify the de-identified facial image.

The performing of the de-identification may include using generative artificial intelligence and generating a de-identified facial image based on the guide provided corresponding to the portion to be newly generated.

The extracting of the feature information may include learning parameters related to forward transformation from a facial image to noise using a diffusion model. The performing of the de-identification may include generating a de-identified facial image from the noise by reverse transformation of the diffusion model based on the guide which removes or modifies feature information. The performing of the de-identification may include during the reverse transformation of the diffusion model, first using features extracted from images in relatively larger grid regions and using features extracted from images in gradually smaller grid regions to generate the facial image.

In order to the above-described technical problems, in another aspect, there is provided a method of processing biometric information comprising receiving a de-identified image; receiving at least one of feature information of an original image and a transformation rule set for de-identification or a combination thereof; and performing re-identification to restore a facial image from the input de-identified image using the received feature information of the original image or the received transformation rule. The de-identified image is generated by extracting feature information about a facial region from the original image, transforming the extracted feature information to provide a guide for a portion to be generated within the facial region, and performing de-identification based on the provided guide.

The performing of the de-identification may include regenerating feature information removed or modified according to the set transformation rule using the feature information of the original image to restore the facial image.

The de-identified image may be generated by extracting features of a corresponding image through transformation from a high-dimensional image to a low-dimensional image for each exclusive region of different sizes from the input image and transforming the extracted features into a latent space to extract region-specific features; or performing masking to extract structural features of a corresponding image for each grid of different sizes from the input image and aggregating the features extracted from each grid for each region to extract structured feature information.

Furthermore, hereinafter, the present invention provides a computer-readable recording medium in which a program for executing the de-identification method and biometric information processing method has been recorded on a computer.

According to one embodiment of the present disclosure, there is provided a de-identification device including a memory configured to store a program for receiving an image including a facial region and de-identifying the received image, and a processor configured to execute the program stored in the memory, wherein the program includes instructions to extract feature information about the facial region from the image including the facial region, transform the extracted feature information to provide a guide for a portion to be generated within the facial region, and perform de-identification based on the provided guide.

According to another embodiment of the present disclosure, there is provided a biometric information processing device including a memory configured to store a program for receiving and re-identifying a de-identified image, and a processor configured to execute a program stored in the memory, wherein the program includes instructions to receive a de-identified image, receive at least one of feature information of an original image and a transformation rule set for de-identification, or a combination thereof, and perform re-identification to restore a facial image from the input de-identified image using the received feature information of the original image or the received transformation rule, and the de-identified image is generated by extracting feature information about the facial region from the original image, transforming the extracted feature information to provide a guide for a portion to be generated within the facial region, and performing de-identification based on the provided guide.

According to various embodiments of the present disclosure, by extracting region-specific features or transforming the feature information obtained through grid-based masking to perform de-identification, the visual features within the images can be protected and partial information reflecting the features from each region can be preserved, thereby generating a natural face that is easily recognizable by humans, and by separately storing and using the feature information or the transformation rule, re-identification that restores the visual features of the original image can be achieved.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 is a view for describing a process for de-identifying or re-identifying visual features within an image including personal information.

FIGS. 2A to 2G are views illustrating the results of applying various de-identification algorithms to a face.

FIG. 3 is a view illustrating an overview of a de-identification process according to various embodiments of the present disclosure.

FIG. 4 is a flowchart illustrating a de-identification method according to one embodiment of the present disclosure.

FIG. 5 is a view for describing a process of extracting features in units of region when extracting feature information about a facial region.

FIG. 6 is a view for describing a process of performing grid-based masking when extracting feature information about a facial region.

FIG. 7 is a view for describing a process of generating a de-identified image using a diffusion model.

FIG. 8 is a flowchart illustrating a method for processing biometric information based on de-identification according to another embodiment of the present disclosure.

FIG. 9 is a block diagram illustrating a de-identification device and a re-identification device according to still another embodiment of the present disclosure.

### DETAILED DESCRIPTION

Reference will now be made in detail to embodiments of the disclosure, examples of which are illustrated in the accompanying drawings. Detailed descriptions of known arts will be omitted if such may mislead the gist of embodiments of the present disclosure. In addition, throughout the present disclosure, “comprising” a certain component means that other components may be further comprised, not that other components are excluded, unless otherwise stated.

Terms used in the present disclosure are only used to describe specific embodiments, and are not intended to limit the present disclosure. Expressions in the singular form include the meaning of the plural form unless they clearly mean otherwise in the context. In the present disclosure, expressions such as “comprise” or “have” are intended to mean that the described features, numbers, steps, operations, components, parts, or combinations thereof exist, and should not be understood to be intended to exclude in advance the presence or possibility of addition of one or more other features, numbers, steps, operations, components, parts, or combinations thereof.

Unless otherwise specified, all of the terms which are used herein, including the technical or scientific terms, have the same meanings as those that are generally understood by a person having ordinary skill in the art to which the present disclosure pertains. The terms defined in a generally used dictionary can be understood to have meanings identical to those used in the context of a related art, and are not to be construed to have ideal or excessively formal meanings unless they are obviously specified in the present disclosure.

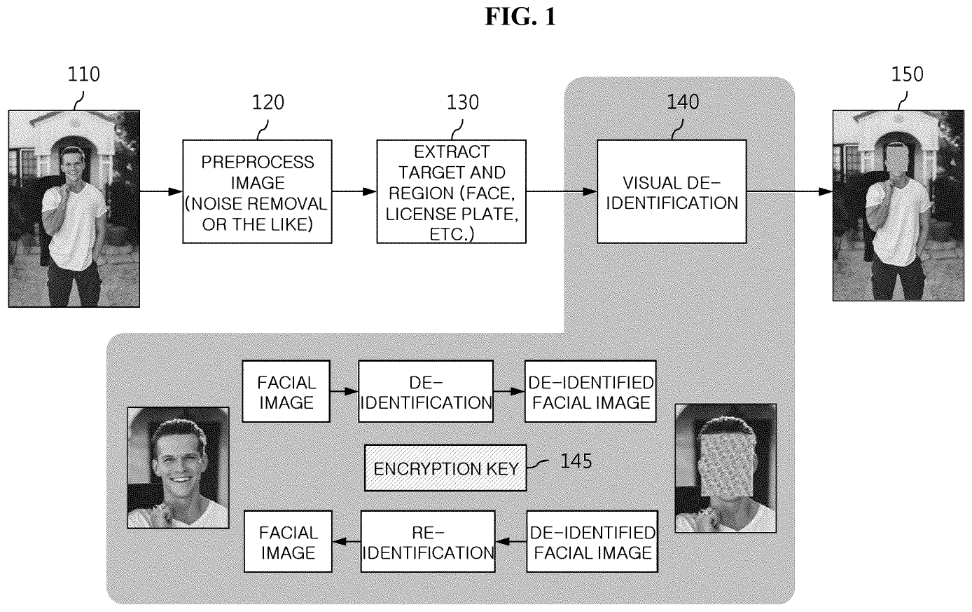

FIG. 1 is a view for describing a process for de-identifying or re-identifying visual features within an image including personal information.

When an original image 110 is input and a series of image processing processes 120, 130, and 140 are performed on the original image 110, a de-identified image 150 may be obtained. Here, a target of de-identification may be a “face” in which personal information or visual features capable of identifying an individual are concentrated.

The series of image processing processes include setting a region of interest (ROI) and replacing the region of interest with another image or data. When de-identified feature information needs to be restored in the future, the original image may be restored by a legally authorized person. Technically, the possibility of restoration may vary depending on the operation policy of the owner or manager, and FIG. 1 assumes a case in which restoration is possible, that is, a reversible de-identification process.

The image processing process for de-identification may include the following three operations.
1) An image preprocessing operation 120: Before image processing, the system resizes an original image or reduces noise in the original image. As illustrated in FIG. 1, in an image including a face, the system may detect people first by prioritizing the background or other objects.
2) An object and region extraction operation 130: The system extracts an image region of a target object based on a de-identification target. In particular, objects may be aligned around an ROI or a specific object may be extracted.
3) A visual de-identification operation 140: Specific de-identification mechanisms, such as black box, blurring, pixilation, eigenface, and the like, may be applied to remove or modify the unique characteristics of the corresponding person.

The visual de-identification operation 140 may be implemented in various forms.

One method is to modify identification data using an irreversible loss function. This method cannot restore the original information due to the transformation, but reduces the probability of re-identification in terms of de-identification. This is a typical de-identification process in terms of visual data.

Another method involves cryptographic assistance, enabling re-identification if necessary. In this case, since the information content is not reduced, re-identification may be attempted if necessary, but there is an inherent risk of personal information leakage.

Another method involves de-identification by removing or changing a person's facial features. As a result, “me who is not me” may be created. This method removes identifying features from the face, and although other features remaining in the image still give the appearance of a human face, the de-identified face makes it difficult to clearly identify the individual. In some cases, this method may create the impression of a similar person to the original image and subtly make the person appear different. Furthermore, acquaintances of the person may perceive the image as similar, but facial recognition algorithms may determine that the two individuals are different. This is because the unique facial features have been removed or modified, causing the facial recognition algorithm to identify the corresponding person as a different individual. In various embodiments of the present disclosure, the privacy to be protected refers to facial features of an individual, but these features refer to a means of distinguishing an individual's identity from the perspective of a device, machine, or algorithm that attempts to identify the individual from others.

Referring to FIG. 1, the visual de-identification operation 140 shows that de-identification may be applied to a previously acquired facial image to obtain a de-identified facial image. In this case, unique information that determines the transformation rule, feature information, or encryption method for the de-identification process may be separately stored in preparation for future restoration requests. An encryption key 145 is illustrated in FIG. 1, but other de-identification techniques may be applied, in addition to encryption. Next, when a restoration request for a de-identified facial image occurs, re-identification may be performed using the pre-stored encryption key 145 or the transformation rule or feature information to obtain a restored facial image.

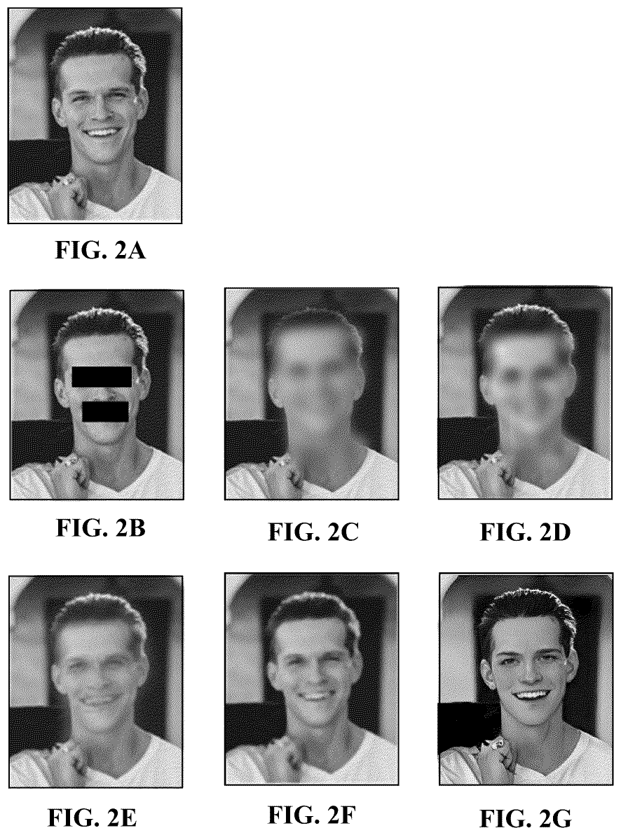

FIGS. 2A to 2G illustrates the results of applying various de-identification algorithms to a face, and illustrates techniques for removing identifiable visual features.

FIG. 2A illustrates an original face image to be de-identified.

FIG. 2B illustrates the de-identification result using a black box technique. This technique differs slightly from the typical mosaic technique in that a portion of the image is erased. The mosaic technique tiles a portion, while the black box technique erases the entire region, resulting in excellent de-identification performance, but conversely, this method may result in significant information loss.

FIG. 2C illustrates the de-identification result using a blurring technique. This technique prevents information leakage by fragmenting data and reducing its clarity. However, blurring is difficult to recommend because restoration techniques are quickly improving depending on the level, and operational performance thereof is similar to that of mosaicking.

FIG. 2D illustrates the de-identification result using a pixilation technique. This technique includes all methods of removing or transforming some data containing personal information, and blurring corresponds to this category in a broad sense. However, since the purpose is to modify specific information or image regions, this technique may be used for restoration or other purposes if necessary.

FIG. 2E illustrates the de-identification result using an Eigenface technique. This technique processes facial information while maintaining some of personal attribute information, and the Eigenface method transforms the eigen-information from a facial image of an individual. By transforming unique information in this way, a small amount of data may be used to transform one person into another, and restoration is also possible with a small amount of data if necessary. However, a key challenge of this technique is how to ensure the security of the personal attribute information.

FIG. 2F illustrates the de-identification result using a K-same technique. In this technique, a human face is represented with overlapping facial information from multiple individuals, and by overlapping the facial information from several people, the specificity and limitations to a single individual can be prevented. The K-same technique can be relatively easily implemented, but may distinguish several faces using frequency characteristics and is not regarded as a complete de-identification method.

FIG. 2G illustrates the de-identification result using a cartoonization technique. This technique is a type of style conversion that combines or modifies data included in existing facial data into a different format. The cartoonization technique illustrated guarantees a certain level of anonymity while maintaining the characteristics of the original photo. However, even in this case, a significant portion of the data included in the original photo is lost, making restoration highly unlikely or requiring separate storage technology. The style conversion technique has an advantage of maintaining some of the original characteristics, and the modified photo also maintains the characteristics of the original, resulting in a more natural look.

Various embodiments presented below are a generation-based de-identification technique, which are proposed to address the weaknesses of various de-identification techniques. Unlike conventional mathematical models or redundant data, the generation-based de-identification technique uses data from a cognitive perspective, and thus unlike conventional techniques, the generation-based de-identification technique does not require user resistance and may be restored or transformed using a small amount of data as needed.

Various embodiments of the present disclosure propose a guide-based generation technique that preserves shape and characteristics. The guide-based generation technique recognizes the feature points of facial information and use the feature points as guides to generate the facial information. That is, this technique preserves specific parts that reflect features from each region, rather than feature points, during the process of generating de-identified virtual facial data and uses the guides to generate other parts. To this end, a guide for a part to be masked is provided, and a de-identified facial image is generated based on the guide. In particular, this technique is to generate facial features that prevent the loss of data to be protected by adding additional data to the facial features. The addition of the additional data can be achieved through the following synthesis methods.
1) Facial feature and segmentation synthesis: This method recognizes facial features, segments features, and generates facial features. This method modifies key facial features and preserves the existing data as much as possible, making it applicable even when only the desired portion is modified in situations with low completeness or heterogeneity. In addition, the segmentation itself provides security.
2) Facial feature and regional part synthesis: Previous segmentation methods crop and process feature parts, while this method pre-segments multiple parts of the face and transforms classified data. This method reveals features that modify parts that people perceive as cognitively important. Accordingly, this method addresses general aspects rather than the importance of data.
3) Facial feature, regional part of face, and grid-based masking synthesis: In addition to using features for each region, this method masks each part using a grid. Through masking, local data is preserved and then expanded, enabling de-identification.

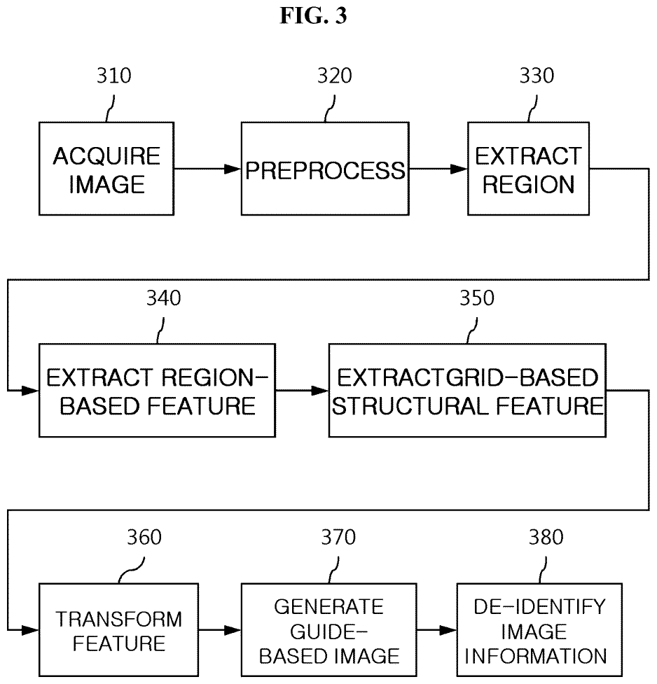

FIG. 3 is a view illustrating an overview of a de-identification process according to various embodiments of the present disclosure. During the de-identification process, decisions may be made as to which regions to target, what information to modify, and how to modify the feature information.

First, an image including a facial region is acquired (310) and preprocessed (320), and then a target region (e.g., a face) is extracted (330). Various embodiments of the present disclosure target significantly preprocessed images (e.g., shadow removal, noise removal, or the like) and assume that deformation or color changes in the acquired image may be corrected through the preprocessing process. Accordingly, it is assumed that images are acquired and preprocessed to achieve an appropriate level of image quality, allowing for the presence of partial occlusions.

Various embodiments of present disclosure target faces, but may include facial information from similar animals and insects. That is, unlike conventional facial recognition technologies that limit key feature points to human faces, this technology encompasses individual facial features. Conventional facial recognition relies on using predetermined key feature points for speed, but the present disclosure may include all information required to specify a specific object.

Then, features may be extracted from the extracted target region using at least one of the two methods.

First, during a region-based feature extraction process 340, features are extracted by varying an input process for size-specific segments from the target image input for learning. To extract features, a method of inputting features extracted from the size-specific segments into individual layers as intermediate information during a process of transforming information from each image region into a latent space.

Second, during a grid-based structural feature extraction process 350, facial information is divided into grids of various sizes, features are extracted, and feature sets for each grid area are overlapped to generate structured feature information.

Next, features to be maintained remain, and features to be removed or modified are transformed according to preset rules or policies (360). Accordingly, a guide-based image is generated (370), thereby achieving image information de-identification (380).

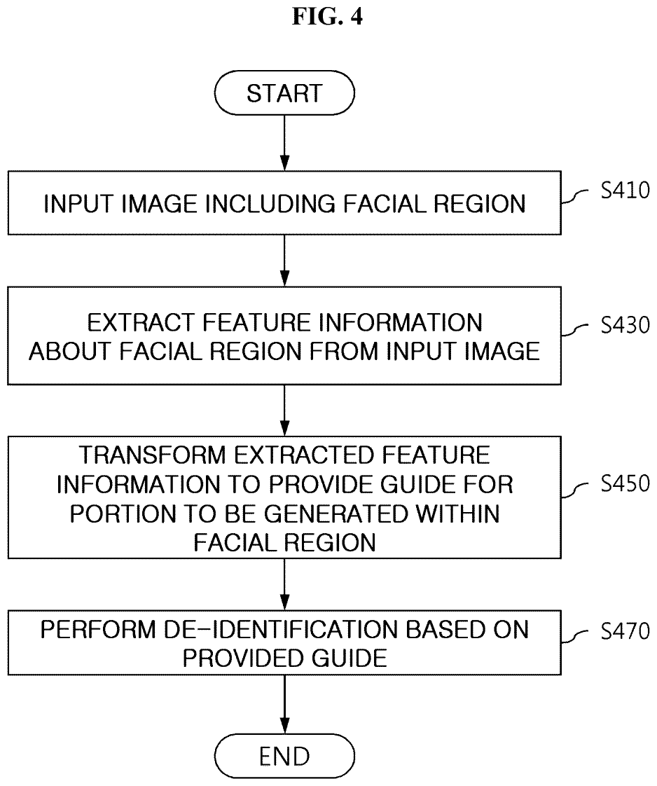

FIG. 4 is a flowchart illustrating a de-identification method according to one embodiment of the present disclosure and describes a series of image processing processes that may be performed by a de-identification device including at least one processor.

In operation S410, the de-identification device receives an image including a facial region. In this case, at least one preprocessing among shadow removal, noise removal, image modification, and color correction may be performed on the input image.

In operation S430, the de-identification device extracts feature information about the facial region from the image input through operation S410. This process may include at least one of extracting region-specific features from the input image in different region sizes, and performing masking on the input image in grid units of different sizes.

Feature extraction may be performed by extracting features from the entire face or finding predefined features. However, these methods can have the side effect that information from regions with strong features occludes information from other regions. To prevent this, various embodiments of the present disclosure propose a technique for extracting features from various regions.

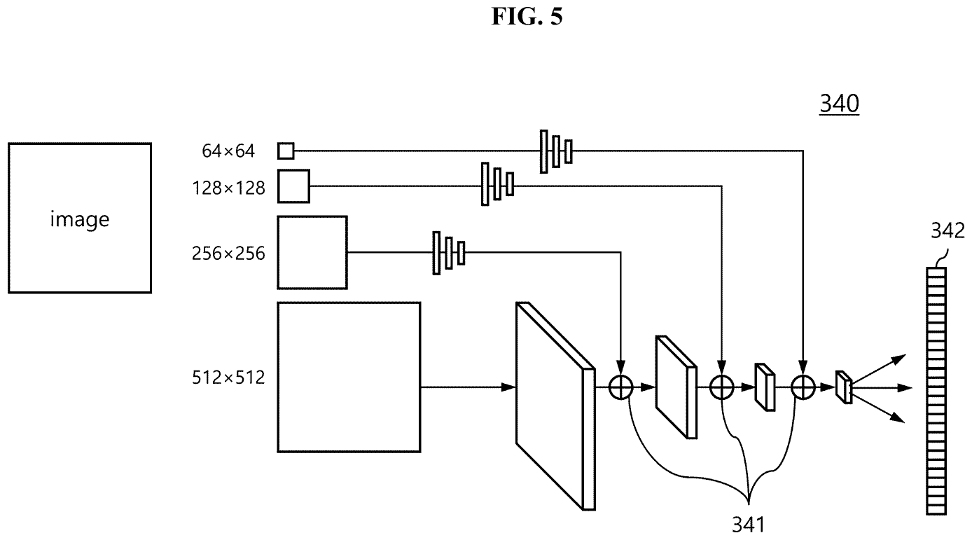

FIG. 5 is a view for describing the process of extracting features in units of region (340) when extracting feature information about a facial region.

When features are extracted from the entire image region, the structure of the learning system is determined regardless of the size of the input image, and thus feature extraction is performed by transforming the image to a predetermined size. Accordingly, when the image may not include features larger than or equal to a specific size, there is a risk of losing important information. Accordingly, one embodiment of the present disclosure proposes a method of extracting features by inputting information about each image region of each size into individual layers during the process of transforming information from the image region into a latent space. Referring to FIG. 5, it can be seen that information about image regions extracted in units of different small sizes is added to individual layers during the process of extracting features of the largest region (341). Since there is a difference between information input during a process of learning feature points and information directly input from individual layers, FIG. 5 illustrates a technique of operating differently depending on the size of the target image input for learning. That is, by extracting features through different input processes for large and small regions, a final latent vector 342 may be obtained. With respect to the produced results, the embodiment of FIG. 5 may further highlight features that operate significantly in small regions. For example, in the case of a small dot on a face, it is difficult to reflect the features of the small dot by extracting features from the entire image region, but in the method of extracting features in units of region, the information representing the small dot is processed separately, allowing for accurate reflection of the visual features of the corresponding information, even at a small size.

Regarding the process of transforming information from an image region into a latent space, FIG. 5 illustrates a method of adding information about image regions extracted from each of relatively smaller image regions (e.g., 256×256, 128×128, 64×64, or the like) with respect to the largest image region (512×512) to individual layers, but this is merely one embodiment and is not limited thereto. For example, it is possible to accumulate information about image regions extracted from each region in a cascade manner. That is, by adding information extracted from a 64×64 image region to a 128×128 image region, adding information extracted from the 128×128 image region to a 256×256 image region, and adding information extracted from the 256×256 image region to a 512×512 image region, information acquired from image regions of different sizes may be hierarchically input into the next stage of the latent space transformation process.

In summary, the process of extracting features from each region may segment the entire image region into exclusive regions of different sizes, and for each segmented exclusive region, the features of the image may be extracted by transforming a high-dimensional image into a low-dimensional image, and then mapped into a latent space, and the image information obtained from relatively smaller regions may be provided as inputs to individual layers during the transformation process of image data corresponding to relatively larger regions, with the input adjusted to match the size of the larger regions.

The above technique for extracting features from each region highlights small features, while the technique to be introduced next segments facial information into grids of different sizes, processes the segmented facial information, and then reassembles the processed facial information to generate structured feature information.

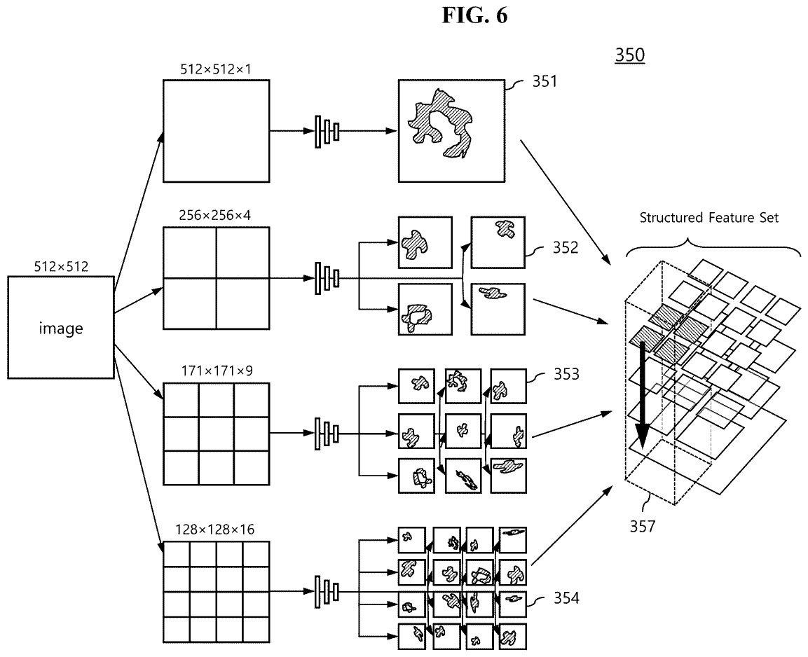

FIG. 6 is a view for describing a process of performing grid-based masking (350) when extracting feature information about a facial region.

Referring to FIG. 6, for example, a method of segmenting the entire image of 512×512 size into grids consisting of 1 image, 4 images of ¼ size (256×256), 9 images of 1/9 size (171×171), 16 images of 1/16 size (128×128), and 25 images of 1/25 size (82×82), processing each grid region, and then restructuring the processed regions is applied. Referring to FIG. 6, feature information 351, 352, 353, and 354 derived from grids of different sizes is illustrated, showing that these are aggregated into a structured feature set.

The grid structure is not configured to repeatedly segment the original region into gradually smaller sizes, such as 1→¼→ 1/16, but rather to be segmented by various ratios, such as 1, ¼, 1/9, and 1/16, so that some overlapping regions are included. That is, grid regions segmented into different sizes may derive features from different perspectives with respect to adjacent regions. In the present embodiment, information about skin tone in the parts and the segmented regions may be included to extract small feature points. Regarding the overlapping grid regions, instead of the four 256×256 images illustrated in FIG. 6, four 300×300 images may be configured. In this case, considering the original image size of 512×512, the four segmented grids may be implemented to overlap each other.

The feature information 351, 352, 353, and 354 derived from grids of different sizes are stacked to correspond to the entire image region, forming a structured feature set. In this case, the entire structured feature set includes features extracted from various perspectives (grid segmentation method) of the entire image region. Accordingly, depending on the transformation rule or purpose, the structured feature set may be used in its entirety or in part. A partial feature set 357 illustrated in FIG. 6 includes feature information derived from grids of different sizes accumulated in the corresponding image region and includes, for example, feature information about four 128×128 images. To focus on features of some specific regions rather than the entire image region, only a portion of the structured feature set corresponding to the corresponding region may be used. For example, to focus on individual features related to lips in an image including the entire body or facial region of a person, only a portion of the structured feature set corresponding to the lips region may be extracted and used for object recognition, transformation, anonymization, etc.

Since the feature point-centered extraction technique for the entire region fail to reflect the overall characteristics of the region, in the present embodiment, the entire region may be segmented into grids of various preset sizes, and feature information may be structured based on these grids, thereby reflecting information about skin features such as spots, freckles, skin tone, skin age, etc. Accordingly, feature information is obtained from relatively large image regions, and features of skin regions are extracted from smaller grid segments and processed into information.

In summary, the masking process may set at least two or more segmentation criteria, segment the entire image region into grids of predetermined sizes according to the set segmentation criteria to extract structural features of the corresponding image for each grid, and grids segmented by different segmentation criteria may overlap in some regions, and aggregate the features extracted from each grid for each region to structure features corresponding to the entire image region. In particular, during the masking process, the skin features may be extracted from relatively smaller grids among the segmented grids.

Referring back to FIG. 4, in operation S450, the de-identification device transforms the feature information extracted in operation S430 to provide a guide for a portion to be generated within the facial region. In this case, feature information corresponding to the portion to be newly generated within the facial region may be removed or modified according to the preset transformation rule.

Previously, in operation S430, the region-based feature extraction, the grid-based feature extraction, and the structuring have been proposed to acquire individual features, and in operation S450, these are used to remove or modify information. The removal or modification of information may be determined according to the user's policies or rules, and the process of generating an image based on the modified information corresponds to the next operation, that is, a guide-based image generation process (operation S470). The type of manipulation to be applied to an object set as an indicator of an individual features may be set using these transformation rules. For example, modification may be instructed to a heatmap with a specific intensity or higher. The heatmap is a tool that visually represents the degree to which data is concentrated in a specific section and may be used to visualize the features of image data. Accordingly, the de-identification method of the present disclosure may use the heatmap to identify which features within a facial image have been focused on, and compare the intensity within the heatmap to a threshold value to reduce an intensity value in regions with an intensity that is greater than or equal to the threshold value, thereby attenuating the individual features. In addition, when the individual characteristics have been previously generated as the structured feature set, the desired feature transformation can be achieved by manipulating the corresponding feature set in its entirety or in part.

From the perspective of implementation, features may be removed or modified by applying a transformation method using feature sets of general people. In many cases, features are transformed based on similar body types or similar races, and such modified information removes individual features, resulting in a person commonly seen in the surrounding environment. When the transformation method and rules are stored during this process, this may be used to restore the feature information of the image in the future. Accordingly, when restoration is necessary, it is preferable to separately record or share the transformation method, policy or rules, and even the feature information. In this case, when the structured feature set is stored, the feature set may be stored in its entirety or in part. However, considering a storage space required to store the structured feature set, only a portion of the feature set may be recorded or shared. For example, in the case of CCTV, already de-identified images may require re-identification for public purposes. Accordingly, at least one of the transformation method, transformation policy or rules, and feature information, or a combination thereof may be stored in a storage of a consignment agency or a separate trusted authority, and authorized users (e.g., police and officials) may use this information to restore the original image from the de-identified image.

In summary, by pre-storing or transmitting at least one of feature information and a transformation rule or a combination thereof in or to a device for re-identifying a de-identified facial image, the de-identified facial image may be used for subsequent image restoration.

A method of storing the original image separately for restoration may also be considered, but due to the nature of images, this method requires storing a large amount of data, and poses a security vulnerability in that the original image is immediately exposed in the event of data leakage. In contrast, according to the transformation rule or minimal information retention method proposed in the present embodiment, the storage space can be maintained in a very small size, and since technical understanding of the restoration process is required, it is possible to provide an advantage of being relatively free from ordinary threats of information leakage.

In operation S470, the de-identification device performs de-identification based on the provided guide. This process may use generative artificial intelligence (AI) and generate a de-identified facial image based on the guide provided corresponding to the portion to be newly generated.

The guide-based image generation technique may first use features extracted from a large image region and use gradually smaller features. In addition, the structured feature information extracted from the grid region is used to generate the image. Through this process, features derived from various methods may be used together. In addition, when shape transformation within an image is required, features extracted from a large image region may be modified, and when changes, such as skin tone, are required, feature transformation may be achieved using the information extracted based on grids.

From the perspective of implementation, various generative AI algorithms and models may be used, and hereinafter, an application technique based on a diffusion model will be provided.

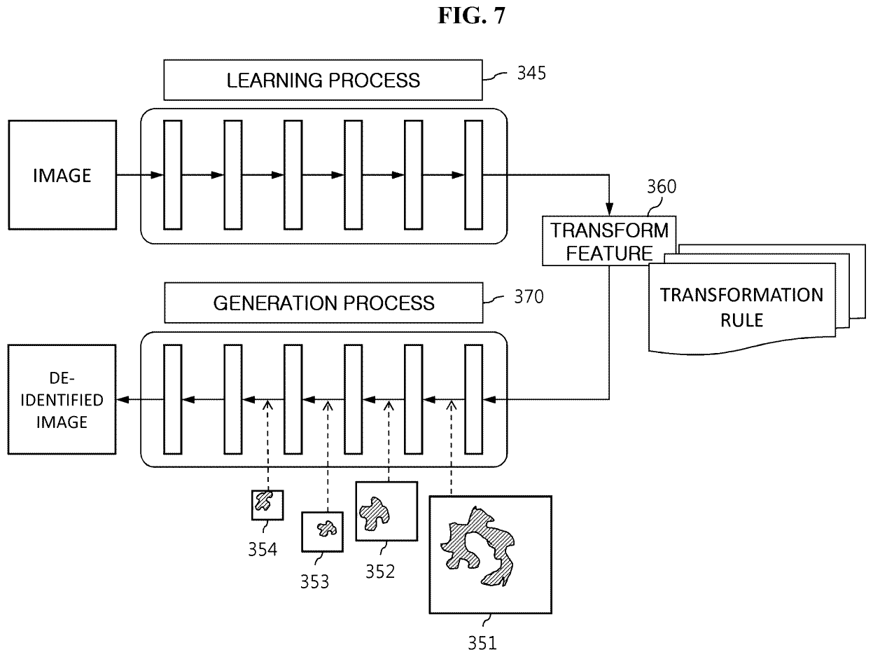

FIG. 7 is a view for describing a process of generating a de-identified image using a diffusion model. The diffusion model is a generative AI technique that uses a forward procedure (or a diffusion procedure) that transforms data into complete noise while gradually adding noise to the data, and conversely, a reverse procedure that generates data through a denoising process of gradually restoring data from noise, and the detailed description of the diffusion model will be omitted.

Referring to FIG. 7, during the process of extracting feature information, parameters for forward transformation from a facial image to noise are learned through the diffusion model (345). This learning process may be implemented, for example, through the process of extracting features from each region in FIG. 5 or the grid-based masking process in FIG. 6.

Then, during the de-identification process, based on the guide that removes or modifies feature information (360), a de-identified facial image is generated from noise by reverse transformation of the diffusion model (370). In this case, during the reverse transformation of the diffusion model, features extracted from images in relatively larger grid regions may be first used, and features extracted from images in gradually smaller grid regions may be used to generate the facial image. Referring to FIG. 7, it can be seen that the feature information 351, 352, 353, and 354 extracted for each grid size in FIG. 6 are provided to the operations of the reverse transformation, respectively, in descending order of size. Through this generation process 370, a de-identified image meeting the requirements of feature transformation 360 is ultimately generated.

As illustrated in FIG. 7, the diffusion model proposed in the present embodiment may learn an image (345) by obtaining features extracted from each region in the forward transformation or features extracted through the grid-based masking, and by inputting these acquired features while gradually reducing the target region during the reverse transformation process, a de-identified image meeting the requirements of feature transformation (360) may be generated (370) without losing the remaining features of the facial region. In particular, the features extracted through the learning process 345 are used step by step for each region size during the image generation process 370.

The diffusion model proposed in the present embodiment may be implemented using stable diffusion or its derivative models. Accordingly, the diffusion model of FIG. 7 may include components, such as a U-Net, an autoencoder, a transformer, and attention, within the latent space and process noise-to-image modification and inverse transformation mapping through the diffusion function and the U-Net.

The guide-based de-identification method has been described above. Hereinafter, a method of restoring an original facial image through re-identification will be proposed.

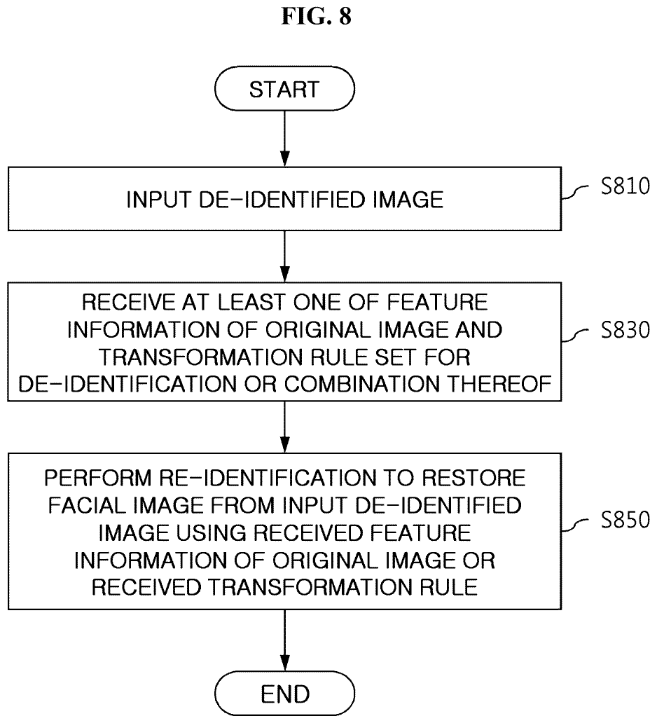

FIG. 8 is a flowchart illustrating a method of processing biometric information based on de-identification according to another embodiment of the present disclosure, and describes a series of image processing processes that may be performed by a biometric information processing device (or a re-identification device) including at least one processor.

In operation S810, the biometric information processing device receives a de-identified image. Here, the de-identified image is generated by extracting feature information about a facial region from an original image, transforming the extracted feature information to provide a guide for a portion to be generated within the facial region, and performing de-identification based on the provided guide.

Furthermore, the de-identified image may be generated by extracting features of the corresponding image through the transformation from a high-dimensional image to a low-dimensional image for each exclusive region of different sizes from the input image and transforming the extracted features into a latent space, thereby extracting region-specific features. Alternatively, the de-identified image may be generated by performing masking to extract structural features of the corresponding image for each grid of different sizes from the input image and aggregating the features extracted from each grid for each region, thereby extracting structured feature information.

In operation S830, the biometric information processing device receives at least one of the feature information of the original image and the transformation rule set for de-identification, or a combination thereof.

In operation S850, the biometric information processing device performs re-identification to restore a facial image from the de-identified image input through operation S810 using the feature information of the original image received through operation S830 or the transformation rule. More specifically, the re-identification process may restore a facial image by regenerating feature information that has been removed or modified according to the set transformation rule using the feature information of the original image. In particular, considering that the structured feature set may be used in its entirety or in part during the image de-identification process, it is noteworthy that facial image restoration is possible using only a portion of the feature information that was subject to modification. Considering the available data storage space required for re-identification, only a portion of this feature set may be used for de-identification or re-identification.

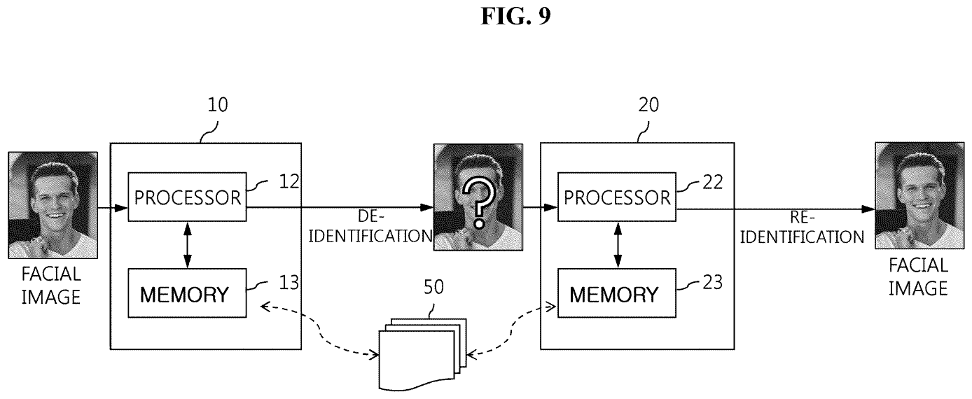

FIG. 9 is a block diagram illustrating a de-identification device 10 and a re-identification device 20 according to still another embodiment of the present disclosure, reconstructing the image processing processes of FIGS. 4 and 8 from the perspective of a hardware configuration. Accordingly, to avoid overlapping descriptions, the components of each device are briefly described herein, focusing on their functions.

The de-identification device 10 includes a memory 13 for storing a program for receiving an image including a facial region and de-identifying the received image, and a processor 12 for executing the program stored in the memory 13. Here, the program includes instructions to extract feature information about the facial region from the image including the facial region, transform the extracted feature information to provide a guide for a portion to be generated within the facial region, and perform de-identification based on the provided guide. The de-identification device 10 preferably stores or transmits at least one of the feature information extracted from the original image and the transformation rule for de-identification in or to the device 20 for re-identifying the de-identified facial image in advance.

The re-identification device (or the biometric information processing device) 20 includes a memory 23 for storing a program for receiving a de-identified image and de-identifying the received de-identified image, and a processor 22 for executing the program stored in the memory 23. Here, the de-identified image is generated by extracting feature information about a facial region from an original image, transforming the extracted feature information to provide a guide for a portion to be generated within the facial region, and performing de-identification based on the provided guide. In addition, the program includes instructions to receive a de-identified image, receive at least one of the feature information of the original image and the transformation rule set for de-identification, or a combination 50 thereof, and perform re-identification to restore a facial image from the input de-identified image using the received feature information of the original image or the transformation rule.

In FIG. 9, the de-identification device 10 and the re-identification device 20 preferably transmit, receive, or share at least one of the feature information of the original image and the transformation rule set for de-identification, or a combination 50 thereof. Accordingly, the re-identification device 20 may restore the original facial image from the de-identified image.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like. When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

Embodiments of the present disclosure can be implemented as computer-readable codes on a computer-readable recording medium. The computer-readable recording medium includes all types of recording devices in which data readable by a computer system is stored. Examples of the computer-readable recording medium include a ROM, a RAM, a CD-ROM, a magnetic tape, a floppy disk, an optical data storage device, etc. Further, the computer-readable recording medium may be distributed to computer systems connected over a network, and computer-readable codes may be stored and executed in a distributed manner. Functional programs, codes, and code segments for implementing embodiments of the present disclosure can be easily construed by programmers skilled in the art to which the present disclosure pertains.

According to various embodiments of the present disclosure, by extracting region-specific features or transforming the feature information obtained through grid-based masking to perform de-identification, the visual features within the images can be protected and partial information reflecting the features from each region can be preserved, thereby generating a natural face that is easily recognizable by humans, and by separately storing and using the feature information or the transformation rule, re-identification that restores the visual features of the original image can be achieved.

As described above, the present disclosure has been examined focusing on its various embodiments. A person with ordinary skills in the technical field to which the present disclosure pertains will be able to understand that the various embodiments can be implemented in modified forms within the scope of the essential characteristics of the present disclosure. Therefore, the disclosed embodiments are to be considered illustrative rather than restrictive. The scope of the present disclosure is shown in the claims rather than the foregoing description, and all differences within the scope should be construed as being included in the present disclosure.

What is claimed is:

1. A de-identification method comprising:
receiving an image including a facial region;
extracting feature information about the facial region from the input image;
transforming the extracted feature information to provide a guide for a portion to be generated within the facial region; and
performing de-identification based on the provided guide.

2. The de-identification method of claim 1, further comprising performing at least one preprocessing among shadow removal, noise removal, image modification, and color correction on the input image.

3. The de-identification method of claim 1, wherein the extracting of the feature information includes at least one of:
extracting region-specific features from the input image in different region sizes; and
performing masking on the input image in grid units of different sizes.

4. The de-identification method of claim 3, wherein the extracting of the region-specific features includes:
segmenting an entire image region into exclusive regions of different sizes, extracting features of the corresponding image through transformation from a high-dimensional image to a low-dimensional image for each segmented exclusive region, and transforming the extracted features into a latent space; and
supplying image information corresponding to a relatively smaller region as inputs to individual layers during the transformation process of image data corresponding to relatively larger regions, with the input adjusted to match the size of the larger regions.

5. The de-identification method of claim 3, wherein the performing of the masking includes:
setting at least two or more segmentation criteria, segmenting the entire image region into grids of predetermined sizes according to the set segmentation criteria to extract structural features of the corresponding image for each grid, with grids segmented by different segmentation criteria overlapping in some regions; and
aggregating the features extracted from each grid for each region to structure features corresponding to the entire image region.

6. The de-identification method of claim 5, wherein the performing of the masking includes
extracting a skin feature from a relatively smaller grid among the segmented grids.

7. The de-identification method of claim 1, wherein the providing of the guide includes
removing or modifying the feature information corresponding to the portion to be newly generated within the facial region according to a preset transformation rule.

8. The de-identification method of claim 7, further comprising pre-storing or transmitting at least one of the feature information and the transformation rule or a combination thereof in or to a device configured to re-identify the de-identified facial image.

9. The de-identification method of claim 1, wherein the performing of the de-identification includes
using generative artificial intelligence and generating a de-identified facial image based on the guide provided corresponding to the portion to be newly generated.

10. The de-identification method of claim 1, wherein the extracting of the feature information includes
learning parameters related to forward transformation from a facial image to noise using a diffusion model, and
the performing of the de-identification includes
generating a de-identified facial image from the noise by reverse transformation of the diffusion model based on the guide which removes or modifies feature information.

11. The de-identification method of claim 10, wherein the performing of the de-identification includes
during the reverse transformation of the diffusion model, first using features extracted from images in relatively larger grid regions and using features extracted from images in gradually smaller grid regions to generate the facial image.

12. A method of processing biometric information, comprising:
receiving a de-identified image;
receiving at least one of feature information of an original image and a transformation rule set for de-identification or a combination thereof; and
performing re-identification to restore a facial image from the input de-identified image using the received feature information of the original image or the received transformation rule,
wherein the de-identified image is generated by extracting feature information about a facial region from the original image, transforming the extracted feature information to provide a guide for a portion to be generated within the facial region, and performing de-identification based on the provided guide.

13. The method of claim 12, wherein the performing of the de-identification includes
regenerating feature information removed or modified according to the set transformation rule using the feature information of the original image to restore the facial image.

14. The method of claim 12, wherein the de-identified image is generated by:
extracting features of a corresponding image through transformation from a high-dimensional image to a low-dimensional image for each exclusive region of different sizes from the input image and transforming the extracted features into a latent space to extract region-specific features; or
performing masking to extract structural features of a corresponding image for each grid of different sizes from the input image and aggregating the features extracted from each grid for each region to extract structured feature information.

15. One or more non-transitory computer-readable media which store one or more instructions,
wherein the one or more instructions executable by one or more processors are configured to:
receive an image including a facial region and perform de-identification;
extract features of a corresponding image through transformation from a high-dimensional image to a low-dimensional image for each exclusive region of different sizes from the input image and transform the extracted features into a latent space to extract region-specific features, or perform masking to extract structural features of the corresponding image by each grid of different sizes from the input image and aggregate the features extracted from each grid by region to extract structured feature information;
transform the extracted feature information to provide a guide for a portion to be generated within the facial region; and
use generative artificial intelligence and generate a de-identified facial image based on the guide provided corresponding to the portion to be newly generated.
